(19) United States
(12) Patent Application Publication
(10) Pub. No.: US 2010/0159386 A1
(43) Pub. Date: Jun. 24, 2010

(54) METHOD FOR PRODUCING DEVELOPING AGENT

(75) Inventors: Takashi Urabe, Shizuoka-ken (JP); Takayasu Aoki, Shizuoka-ken (JP); Tsuyoshi Itou, Shizuoka-ken (JP); Motonari Udo, Shizuoka-ken (JP); Satoshi Araki, Shizuoka-ken (JP); Masahiro Ikuta, Shizuoka-ken (JP); Takafumi Hara, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/638,168

(22) Filed: Dec. 15, 2009

Related U.S. Application Data
(60) Provisional application No. 61/140,008, filed on Dec. 22, 2008.

(51) Int. Cl. G03G 9/08

(52) U.S. Cl. 430/137.14

(57) ABSTRACT

A method for producing a developing agent, wherein in the formation of aggregated particles, particles in a dispersion liquid have a volume average particle diameter of 2 μm or less when the pH of the dispersion liquid is 7, and also the pH of the dispersion liquid is from 3.0 to 6.9 when the zeta potential of the particles is −30 mV.

### CROSS-REFERENCE TO RELATED APPLICATIONS

This application is based upon and claims the benefit of priority from U.S. Provisional Application No. 61/140,008, filed Dec. 22, 2008, the entire contents of which are incorporated herein by reference.

### TECHNICAL FIELD

The present invention relates to a method for producing a developing agent to be used for developing an electrostatic image or a magnetic latent image in electrophotography, electrostatic printing, magnetic recording, and the like.

### BACKGROUND

In electrophotography, an electric latent image is formed on an image carrying member, subsequently the latent image is developed with a toner to form a toner image, and the toner image is transferred to a transfer material such as paper and fixed thereon by means of heating, pressurizing or the like, whereby an image is formed. In order to form a full color image, not only a black toner, but also toners of a plurality of colors are used to form an image.

As the toner, a two-component developing agent to be used by mixing with carrier particles and a one-component developing agent to be used as a magnetic toner or a non-magnetic toner are known. These toners are generally produced by a kneading pulverization method. This kneading pulverization method is a method for producing desired toner particles by melt-kneading a binder resin, a pigment, a release agent such as a wax, a charge control agent, and the like, cooling the resulting mixture, followed by finely pulverizing the cooled mixture, and then classifying the finely pulverized mixture. Inorganic and/or organic fine particles are added to the surfaces of toner particles produced by the kneading pulverization method in accordance with the intended use, and thus, the toner can be obtained.

When toner particles are produced by the kneading pulverization method, their shape is amorphous and their surface composition is not uniform in general. Although the shape and surface composition of toner particles are subtly changed depending on the pulverizability of the material to be used and conditions for the pulverization process, it is difficult to intentionally control the shape.

Further, when a material with a particularly high pulverizability is used, the particles are further finely pulverized or their shape is changed due to various stresses in a developing machine. As a result, in a two-component developing agent, a problem sometimes arises that the finely pulverized toner is adhered to the surface of a carrier to accelerate deterioration of chargeability of the developing agent. Also, in a one-component developing agent, a problem sometimes arises that the particle size distribution is widened, the finely pulverized toner is scattered, or developability is deteriorated as the toner shape is changed to cause deterioration of image quality.

Further, when the toner contains a release agent such as a wax, pulverization is liable to occur at a boundary between a binder resin and the release agent, and therefore, the release agent is sometimes exposed on the surface of the toner. In particular, when the toner is formed of a resin which has high elasticity and is hardly pulverized and a brittle wax such as polyethylene, exposure of polyethylene on the surface of the toner is much seen. Although such a toner is advantageous in a releasing property during fixing and also is advantageous in cleaning of untransferred toner on a photoconductor, the polyethylene on the surface of the toner is detached from the toner by mechanical force such as shearing force in the developing machine and easily transferred to a developing roll, an image carrying member, a carrier, or the like. Therefore, contamination of the developing roller, image carrying member, carrier, or the like with the wax is easily caused and the reliability as a developing agent is sometimes lowered.

Under such circumstances, recently, as a method for producing a toner in which the shape and surface composition of toner particles are intentionally controlled, an emulsion polymerization aggregation method is proposed in JP-A-63-282752 and JP-A-6-250439.

The emulsion polymerization aggregation method is a method for obtaining toner particles by separately preparing a resin dispersion liquid by emulsion polymerization and a coloring agent dispersion liquid in which a coloring agent is dispersed in a solvent, mixing these dispersion liquids to form aggregated particles with a size corresponding to a toner particle diameter, and fusing the particles by heating. According to this emulsion polymerization aggregation method, the toner shape can be arbitrarily controlled from amorphous to spherical shape by the selection of a heating temperature condition.

In the emulsion polymerization aggregation method, a toner can be obtained by at least subjecting a dispersion liquid containing resin fine particles and a dispersion liquid containing a coloring agent to aggregation and fusion under a predetermined condition. However, in the emulsion polymerization aggregation method, there is a restriction on the type of resin which can be synthesized, and the method cannot be applied to a polyester resin which is known to have a good fixability though the method is suitable for production of a styrene-acrylic copolymer.

On the other hand, as a method for producing a toner using a polyester resin, a phase inversion emulsification method in which a pigment dispersion liquid and the like are added to a solution obtained by dissolving a polyester resin in an organic solvent and then water is added thereto is known, however, it is necessary to remove and recover the organic solvent. JP-A-9-311502 proposes a method for producing fine particles by mechanical shearing in an aqueous medium without using an organic solvent. However, it is necessary to feed a resin or the like in a molten state to a stirring device, and handling thereof is difficult. Further, with the use of this method, the degree of freedom for shape control is low, and the shape of a toner cannot be arbitrarily controlled from amorphous to spherical shape. Further, when a polyester resin is finely pulverized by mechanical shearing in an aqueous medium, hydrolysis thereof occurs, and the molecular weight of the polyester resin is decreased in some cases. A developing agent containing a polyester resin with a decreased molecular weight is likely to aggregate, and therefore, the storage stability is deteriorated. Further, a softening point of a polyester resin is changed as the molecular weight thereof is decreased, and fixability of the developing agent is deteriorated.

Accordingly, as disclosed in, for example, JP-A-2007-323071, a method in which particles containing a polyester resin are finely pulverized and the finely pulverized particles are grown to a toner particle diameter is proposed. However, in this method, it is difficult to obtain a desired toner particle diameter due to an increase in viscosity peculiar to the polyester resin while growing the particles to a toner particle diameter.

### SUMMARY

An object of the invention is to obtain a developing agent having a sharper particle size distribution.

The method for producing a developing agent of the invention includes:

preparing a toner material dispersion liquid by mixing a granular mixture containing a binder resin and a coloring agent with an aqueous medium;

preparing a dispersion liquid containing fine particles having a particle diameter smaller than that of the granular mixture by subjecting the toner material dispersion liquid to mechanical shearing to finely pulverize the granular mixture; and

forming aggregated particles by aggregating the fine particles through pH adjustment of the dispersion liquid containing the fine particles, wherein

in the formation of the aggregated particles, when the pH of the dispersion liquid is 7, the particles in the dispersion liquid have a volume average particle diameter of 2 μm or less, and when the zeta potential of the particles is −30 mV, the pH of the dispersion liquid is from 3.0 to 6.9.

According to the invention, a developing agent having a sharper particle size distribution can be obtained by controlling aggregation of fine particles containing toner materials.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a flowchart showing one example of a method for producing a developing agent of the invention.

FIG. 2 is a graph showing a relationship between the pH of a dispersion liquid and the ζ potential of aggregated particles in a method for producing a developing agent of the invention.

FIG. 3 is a graph showing a relationship between the pH of a dispersion liquid and the volume average particle diameter of aggregated particles in a method for producing a developing agent of the invention.

### DETAILED DESCRIPTION

Hereinafter, the invention is described in more detail with reference to the drawings.

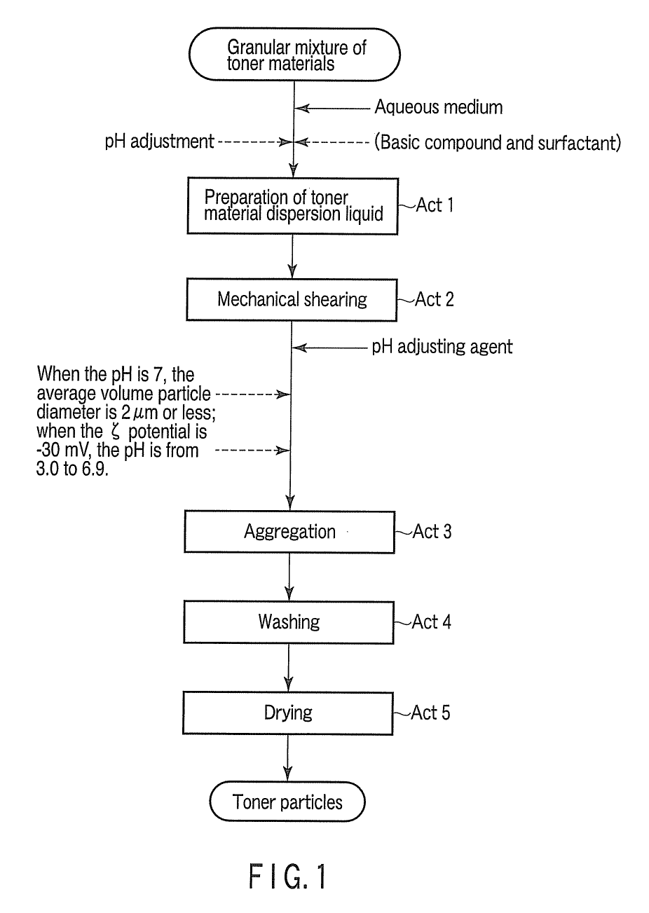

FIG. 1 is a flowchart showing one example of a method for producing a developing agent of the invention.

In the method for producing a developing agent of the invention, first, a toner material dispersion liquid is prepared by mixing a granular mixture containing a binder resin and a coloring agent with an aqueous medium (Act 1).

At this time, the pH adjustment with a basic compound or the like can optionally be performed.

Further, by adding a surfactant or the like, the dispersibility of the granular mixture can be adjusted.

Subsequently, a dispersion liquid containing fine particles having a particle diameter smaller than that of the granular mixture is prepared by subjecting the toner material dispersion liquid to mechanical shearing to finely pulverize the granular mixture (Act 2).

Thereafter, aggregated particles are formed by aggregating the fine particles through pH adjustment of the dispersion liquid containing the fine particles (Act 3).

In the invention, in the formation of the aggregated particles (Act 3), when the pH of the dispersion liquid is 7, the particles in the dispersion liquid have a volume average particle diameter of 2 μm or less, preferably from 0.5 to 2 μm, and when the zeta potential of the particles is −30 mV, the pH of the dispersion liquid is from 3.0 to 6.9.

Further, the aggregated particles are optionally fused by heating, and then, washed (Act 4) and dried (Act 5), whereby toner particles are obtained.

A zeta (ζ) potential measurement method to be used in the invention is as follows.

1. The pH of the colored fine particle dispersion liquid is adjusted by adding hydrochloric acid dropwise thereto (the pH at this time is represented by pH (A)).

2. The concentration of solid content in the colored fine particles at pH (A) is adjusted to 5 ppm with ion exchanged water.

3. The pH of the colored fine particle dispersion liquid after the above-mentioned dilution is adjusted to the same value as pH (A) by adding hydrochloric acid dropwise thereto.

4. The ζ potential of the fine particle dispersion liquid after the pH adjustment is measured under the following conditions.

Measurement device: ZEECOM (manufactured by Microtech Nition Co., Ltd.)

Cell position: 15 mm

Voltage: 70 V

Number of particles to be measured: 50

The production method of the invention is a method for producing an electrophotographic toner by preparing fine particles of toner materials in an aqueous medium and aggregating the fine particles to grow to a desired toner particle diameter, and relates to a technique for producing a toner having a sharp particle size distribution by controlling the ζ potential of the fine particles of toner materials by pH adjustment.

In the method of the invention, when a granular mixture containing a binder resin and a coloring agent is finely pulverized, mechanical shearing is used without using an organic solvent. At this time, in order to facilitate fine pulverization, a pH adjusting agent is used. As the pH adjusting agent, those which make the pH of the resulting dispersion liquid basic can be used. The pH of the toner material dispersion liquid can be set in the range of from 7.2 to 11.5. The ζ potential of the colored fine particles in the dispersion liquid can be set to −32 mV or less, preferably −30 mV or less in order to prevent coalescence.

Examples of the pH adjusting agent to be used for making the pH basic include organic amine compounds such as dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, and N,N-diethyl-1,3-diaminopropane; alkali metal hydroxides such as sodium hydroxide, potassium hydroxide, and lithium hydroxide; and ammonia.

In the step of aggregating fine particles to grow the resulting aggregated particles to a desired toner particle diameter, if a generally used water-soluble metal salt is used, the softening point of the resulting toner is increased due to metal bridging, which inhibits fixing at a low temperature. In view of this, in the method of the invention, the colored fine particles can be aggregated only by pH adjustment with an acid with the proviso that the volume average particle diameter of the aggregated particles at a pH of 7.0 is controlled to be 2.0 μm or less, preferably 0.5 to 2.0 μm. If the volume average particle diameter of the aggregated particles at a pH of 7.0 is more than 2.0 μm, the variation in the particle diameter of the colored fine particles depending on the pH is large, and the particle diameter thereof when a necessary aggregating agent is added dropwise becomes more than 10 μm. Therefore, the particle diameter cannot be intentionally controlled. Meanwhile, if the volume average particle diameter of the aggregated particles is less than 0.5 μm, the aggregated particles cannot be grown to a desired toner particle diameter through pH adjustment with an acid, or fine particles which are not aggregated tend to remain.

Examples of the acid to be used for the pH adjustment include nitric acid, sulfuric acid, hydrochloric acid, acetic acid, acetic anhydride, phosphoric acid, and citric acid.

In the step of forming the aggregated particles, further, an acid is additionally added, and the dropwise addition of the acid is stopped when the ζ potential of the colored fine particle dispersion liquid becomes −30 mV. The pH of the colored fine particle dispersion liquid at this time is in the range of from 3.0 to 6.9. When the ζ potential is not increased to −30 mV or the pH is lower than 3.0, the dispersion stability of the particles is high, and therefore, aggregation of the colored fine particles cannot be controlled.

By using such a fine particle dispersion liquid, a toner having a desired particle diameter can be easily obtained.

In the method for producing a developing agent of the invention, first, a coarsely granulated mixture containing at least a binder resin and a coloring agent is prepared. The coarsely granulated mixture can be obtained by, for example, melt-kneading and coarsely pulverizing a mixture containing a binder resin and a coloring agent. Alternatively, it can be obtained by granulating a mixture containing a binder resin and a coloring agent.

The coarsely granulated mixture preferably has a volume average particle diameter of from 0.012 mm to 0.2 mm. If the volume average particle diameter thereof is less than 0.012 mm, energy for coarse pulverization is large and the productivity decreases. If the volume average particle diameter thereof exceeds 0.2 mm, the coarsely granulated mixture clogs the inside of a pipe or the like installed in a fine pulverization device, or the resulting particle size distribution becomes large.

Subsequently, the coarsely granulated mixture is dispersed in an aqueous medium to form a dispersion liquid of the coarsely granulated mixture.

In a step of forming the dispersion liquid of the coarsely granulated mixture, at least one member of a surfactant and a pH adjusting agent can be optionally added to the aqueous medium.

By the addition of a surfactant, the mixture can be easily dispersed in the aqueous medium due to the action of the surfactant adsorbed onto the surface of the mixture. Further, by the addition of a pH adjusting agent, the degree of dissociation of a dissociable functional group on the surface of the mixture is increased or the polarity is increased, and therefore, the self-dispersibility can be improved.

Subsequently, the resulting dispersion liquid can be heated to a desired temperature. In order to effect fine pulverization, the temperature of the dispersion liquid can be set to a temperature not lower than the glass transition temperature of a binder resin to be used. Further, as the temperature of the dispersion liquid is higher, the colored particles are more finely pulverized, therefore it is advantageous, however, hydrolysis is promoted, resulting in deterioration of fixability or the like. The dispersion liquid heated to a desired temperature is subjected to mechanical shearing to more finely pulverize the coarsely granulated mixture, whereby a dispersion liquid containing fine particles is prepared. At this time, the volume average particle diameter of the fine particles is 1.0 μm or less, preferably from 0.05 to 1.0 μm.

Subsequently, the thus obtained dispersion liquid is cooled to a temperature not higher than the glass transition temperature of the resin. At this time, the dispersion liquid can be cooled to a desired temperature at which aggregation is performed.

To the cooled dispersion liquid, a material for promoting the growth of the particles is added so as to grow the particles to a desired toner particle diameter. In the step of forming aggregated particles, a plurality of fine particles can be aggregated by employing at least one process of pH adjustment, addition of a surfactant, addition of a water-soluble metal salt, addition of an organic solvent, and temperature adjustment. However, in a first stage of aggregation of particles, it is preferred that the particles are aggregated by controlling the ζ potential of the fine particles through pH adjustment with an acid. The acid to be used is not particularly limited, however, it is preferred to use one or more acids selected from nitric acid, sulfuric acid, hydrochloric acid, acetic acid, acetic anhydride, phosphoric acid, and citric acid. In order to further promote aggregation after completion of the first-stage aggregation, one or more of the above-mentioned processes can be used. It is possible to control the shape of the resulting aggregated particles by adjusting these processes.

Subsequently, in order to improve the stability of the aggregated particles, the aggregated particles are fused to one another at a given temperature. The temperature is not particularly limited as long as it is a temperature capable of allowing the aggregated particles to coalesce. However, it is preferred that the fusion is performed at a temperature not lower than the glass transition temperature of the resin, preferably at a temperature higher than the glass transition temperature of the resin by about 5° C. to 80° C. Further, the growth of the particles and fusion thereof may be performed simultaneously or separately as described above.

The aggregated particles or stabilized aggregated particles preferably have a volume average particle diameter of from 2.5 to 10 μm.

The aggregated particles or stabilized aggregated particles preferably have a circularity of from 0.8 to 1.0.

Subsequently, a dispersion liquid containing the aggregated particles or stabilized aggregated particles is cooled to, for example, 5° C. to a temperature not higher than the glass transition temperature of the resin, followed by washing using, for example, a filter press or the like and then drying, whereby toner particles are obtained.

The binder resin to be used in the invention is not particularly limited as long as it is a resin having a dissociable group, however, in consideration of a fixing property and the like, it is preferred to use polyester resins. These resins can be used alone or in combination of two or more kinds thereof.

The binder resin preferably has an acid value of 1 or more.

Examples of the coloring agent to be used in the invention include carbon blacks, and organic or inorganic pigments or dyes. Examples of the carbon black include acetylene black, furnace black, thermal black, channel black, and Ketjen black. Further, examples of a yellow pigment include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, and 185, and C.I. Vat Yellow 1, 3, and 20. These can be used alone or in admixture. Examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, and 238, C.I. Pigment Violet 19, and C.I. Vat Red 1, 2, 10, 13, 15, 23, 29, and 35. These can be used alone or in admixture. Examples of a cyan pigment include C.I. Pigment Blue 2, 3, 15, 16, and 17, C.I. Vat Blue 6, and C.I. Acid Blue 45. These can be used alone or in admixture.

To the coarsely granulated mixture, at least one member of a wax and a charge control agent can be further added.

Examples of the wax include aliphatic hydrocarbon waxes such as low molecular weight polyethylene, low molecular weight polypropylene, polyolefin copolymers, polyolefin waxes, microcrystalline waxes, paraffin waxes, and Fischer-Tropsch waxes; oxides of an aliphatic hydrocarbon wax such as polyethylene oxide waxes or block copolymers thereof; vegetable waxes such as candelilla wax, carnauba wax, Japan wax, jojoba wax, and rice wax; animal waxes such as bees wax, lanolin, and whale wax; mineral waxes such as ozokerite, ceresin, and petrolatum; waxes containing, as the major component, a fatty acid ester such as montanic acid ester wax and castor wax; and deoxidation products resulting from deoxidization of a part or the whole of a fatty acid ester such as deoxidized carnauba wax. Further, saturated linear fatty acids such as palmitic acid, stearic acid, montanic acid, and long-chain alkyl carboxylic acids having a long-chain alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and long-chain alkyl alcohols having a long-chain alkyl group; polyhydric alcohols such as sorbitol; fatty acid amides such as linoleic acid amide, oleic acid amide, and lauric acid amide; saturated fatty acid bisamides such as methylenebis stearic acid amide, ethylenebis caprylic acid amide, ethylenebis lauric acid amide, and hexamethylenebis stearic acid amide; unsaturated fatty acid amides such as ethylenebis oleic acid amide, hexamethylenebis oleic acid amide, N,N′-dioleyl adipic acid amide, and N,N′-dioleyl sebaccic acid amide; aromatic bisamides such as m-xylenebis stearic acid amide and N,N′-distearyl isophthalic acid amide; fatty acid metal salts (generally called metallic soaps) such as calcium stearate, calcium laurate, zinc stearate, and magnesium stearate; waxes obtained by grafting a vinyl monomer such as styrene or acrylic acid onto an aliphatic hydrocarbon wax; partially esterified products of a fatty acid and a polyhydric alcohol such as behenic acid monoglyceride; and methyl ester compounds having a hydroxyl group obtained by hydrogenation of a vegetable fat or oil can be exemplified.

As the charge control agent for controlling a frictional charge quantity which can be used in the invention, for example, a metal-containing azo compound is used, and a complex or a complex salt in which the metal element is iron, cobalt, or chromium, or a mixture thereof is preferred. Other than these, a metal-containing salicylic acid derivative compound can also be used, and a complex or a complex salt in which the metal element is zirconium, zinc, chromium, or boron, or a mixture thereof is preferred.

Examples of the surfactant which can be used in the invention include anionic surfactants such as sulfate-based, sulfonate-based, phosphate-based, and soap-based anionic surfactants; cationic surfactants such as amine salt-type, and quaternary ammonium salt-type cationic surfactants; and nonionic surfactants such as polyethylene glycol-based, alkyl phenol ethylene oxide adduct-based, and polyhydric alcohol-based nonionic surfactants.

Examples of the mechanical shearing device to be used in the invention include mechanical shearing devices which do not use a medium such as ULTRA TURRAX (manufactured by IKA Japan K.K.), T.K. AUTO HOMO MIXER (manufactured by PRIMIX Corporation), T.K. PIPELINE HOMO MIXER (manufactured by PRIMIX Corporation), T.K. FILMICS (manufactured by PRIMIX Corporation), CLEAR MIX (manufactured by M TECHNIQUE Co., Ltd.), CLEAR SS5 (manufactured by M TECHNIQUE Co., Ltd.), CAVITRON (manufactured by EUROTEC, Ltd.), FINE FLOW MILL (manufactured by Pacific Machinery & Engineering Co., Ltd.), MICROFLUIDIZER (manufactured by Mizuho Industry Co., Ltd.), STARBURST (manufactured by Sugino Machine Limited), NANOMIZER (manufactured by Yoshida Kikai Co., Ltd.), Genus PY (manufactured by Hakusui Chemical Industries Co., Ltd.), and NANO 3000 (manufactured by Beryu Co., Ltd.); and mechanical shearing devices which use a medium such as VISCO MILL (manufactured by Aimex Co., Ltd.), APEX MILL (manufactured by Kotobuki Industries Co., Ltd.), STAR MILL (manufactured by Ashizawa Finetech Co., Ltd.), DCP SUPER FLOW (manufactured by Nippon Eirich Co., Ltd.), MP MILL (manufactured by Inoue Manufacturing Co., Ltd.), SPIKE MILL (manufactured by Inoue Manufacturing Co., Ltd.), MIGHTY MILL (manufactured by Inoue Manufacturing Co., Ltd.), and SC MILL (manufactured by Mitsui Mining Co., Ltd.).

In the invention, in order to prepare the coarsely granulated mixture, a mixture containing at least a binder resin and a coloring agent can be kneaded.

A kneader to be used is not particularly limited as long as it can perform melt-kneading, however, examples thereof include single screw extruders, twin screw extruders, pressure kneaders, Banbury mixer, and Brabender mixer. Specific examples thereof include FCM (manufactured by Kobe Steel, Ltd.), NCM (manufactured by Kobe Steel, Ltd.), LCM (manufactured by Kobe Steel, Ltd.), ACM (manufactured by Kobe Steel, Ltd.), KTX (manufactured by Kobe Steel, Ltd.), GT (manufactured by Ikegai, Ltd.), PCM (manufactured by Ikegai, Ltd.), TEX (manufactured by the Japan Steel Works, Ltd.), TEM (manufactured by Toshiba Machine Co., Ltd.), ZSK (manufactured by Warner K.K.), and KNEADEX (manufactured by Mitsui Mining Co., Ltd.).

In the invention, it is preferred to use an acid when the fine particles are aggregated. The kind of acid is not particularly limited, and for example, nitric acid, sulfuric acid, hydrochloric acid, acetic acid, acetic anhydride, or phosphoric acid can be used.

In the invention, in order to adjust the fluidity or chargeability of the toner particles, inorganic fine particles can be added and mixed in the surfaces of the toner particles in an amount of from 0.01 to 20% by weight based on the total weight of the toner. As such inorganic fine particles, silica, titania, alumina, strontium titanate, tin oxide, cerium oxide, and the like can be used alone or in admixture of two or more kinds thereof.

As the inorganic fine particles, those surface-treated with a hydrophobizing agent are preferably used from the viewpoint of improvement of environmental stability. Further, other than such inorganic oxides, resin fine particles with a size of 1 μm or less may be externally added for improving the cleaning property.

Examples of a mixer for inorganic fine particles and the like include Henschel mixer (manufactured by Mitsui Mining Co., Ltd.), Super mixer (manufactured by Kawata Mfg. Co., Ltd.), Libocone (manufactured by Okawara Mfg. Co., Ltd.), Nauta mixer (manufactured by Hosokawa Micron, Co., Ltd.), Turbulizer (manufactured by Hosokawa Micron, Co., Ltd.), Cyclomixer (manufactured by Hosokawa Micron, Co., Ltd.), Spiral Pin Mixer (manufactured by Pacific Machinery & Engineering Co., Ltd.), and Lodige Mixer (manufactured by Matsubo Corporation).

In the invention, further, coarse particles and the like can be sieved out. Examples of a sieving device to be used for sieving include ULTRA SONIC (manufactured by Koei Sangyo Co., Ltd.), GYRO SHIFTER (manufactured by Tokuju Corporation), VIBRASONIC SYSTEM (manufactured by Dalton Co., Ltd.), SONICLEAN (manufactured by Shinto Kogyo K.K.), TURBO SCREENER (manufactured by Turbo Kogyo Co., Ltd.), MICRO SHIFTER (manufactured by Makino Mfg. Co., Ltd.), and a circular vibrating sieve.

By adopting such a configuration, a toner having a sharp particle size distribution can be simply prepared.

### Example 1

90 parts by weight of a polyester resin (glass transition temperature: 58° C., acid value: 6, weight average molecular weight Mw: 13,658) as a binder resin, 5 parts by weight of a cyan pigment as a coloring agent, 4 parts by weight of an ester wax, and 1 part by weight of a zirconia metal complex as a charge control agent were mixed, and the resulting mixture was melt-kneaded using a twin screw kneader which was set to a temperature of 120° C., whereby a kneaded material was obtained.

The thus obtained kneaded material was coarsely pulverized to a volume average particle diameter of 1.2 mm using a hammer mill manufactured by Nara Machinery Co., Ltd., whereby coarse particles were obtained. Subsequently, the thus obtained coarse particles were further pulverized using a pulverizer manufactured by Hosokawa Micron Corporation, whereby moderately pulverized particles having a volume average particle diameter of 58 μm were obtained.

30 parts by weight of the thus obtained moderately pulverized particles, 1 part by weight of sodium dodecylbenzene sulfonate as an anionic surfactant, 1 part by weight of triethylamine as an amine compound and 68 parts by weight of ion exchanged water were stirred using a homogenizer manufactured by IKA Japan K.K., whereby a mixed liquid 1 was obtained.

Subsequently, the thus obtained mixed liquid 1 was fed to a nanomizer (YSNM-2000AR, manufactured by Yoshida Kikai Co., Ltd. provided with a heating system) in which the temperature of the heating system was set to 120° C., and a treatment at a treatment pressure of 150 MPa was repeated 3 times. The volume average particle diameter of the colored fine particles obtained after cooling was measured using SALD-7000 (manufactured by Shimadzu Corporation) and found to be 0.70 μm. The pH of the fine particle dispersion liquid was 8.2.

Subsequently, the dispersion liquid was diluted such that the concentration of the solid content in the colored fine particles was 18%, and then, 0.1 M hydrochloric acid was added dropwise thereto to adjust the pH. The temperature of the dispersion liquid was controlled to 30° C. The particle diameter was measured when the pH became 7.0 and found to be 0.85 μm. 0.1 M hydrochloric acid was further added dropwise thereto, and the dropwise addition was stopped when the ζ potential of the fine particles became −30 mV. The pH at this time was 3.9.

Then, the temperature of the dispersion liquid was raised to 80° C. at a rate of 10° C./min while stirring the dispersion liquid with a paddle impeller (500 rpm), and the dispersion liquid was maintained at 80° C. for 1 hour. After cooling, the dispersion liquid was left overnight as such, and then, the state of the supernatant liquid was observed. As a result, the supernatant liquid was transparent and unaggregated particles were not observed. Further, the volume average particle diameter was measured using a coulter counter (manufactured by Beckman Coulter, Inc., aperture diameter: 100 μm) and found to be 6.3 μm, and coarse particles having a diameter of 20 μm or more were not observed.

### Examples 2 to 8, Comparative Examples 1 to 8

The same procedure as in Example 1 was performed except that the composition of the mixed liquid 1 of Example 1 was changed as shown in the following Table 1. The test results are also shown in the following Table 1.

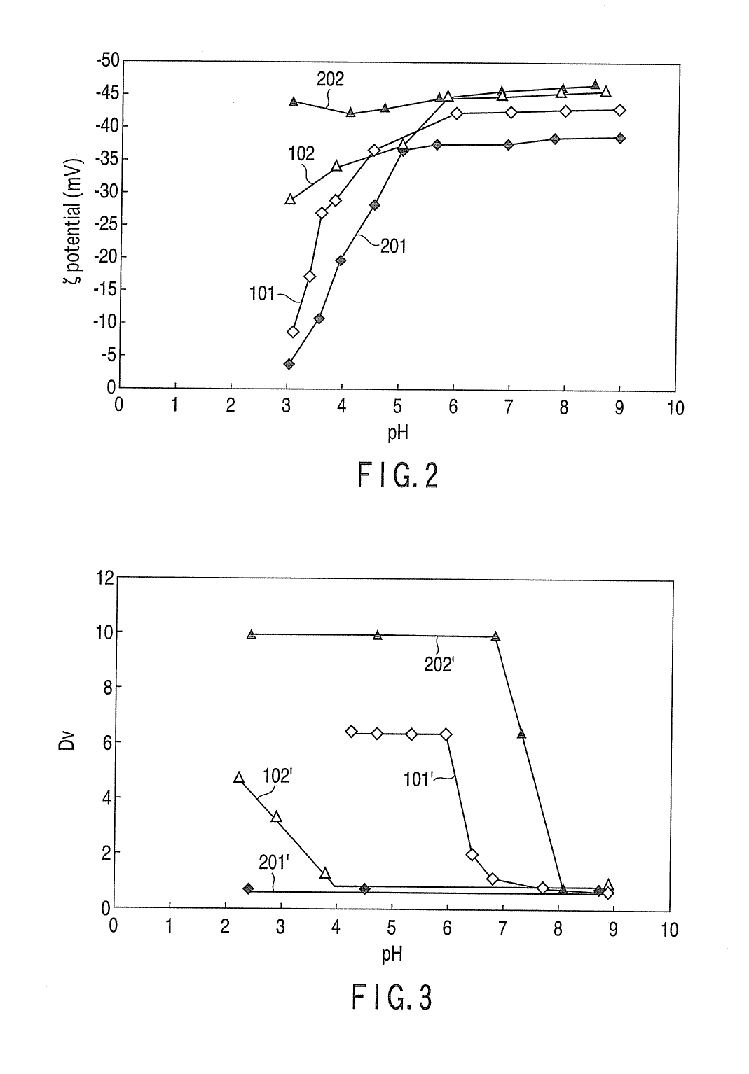

Further, with respect to Examples 1 and 2, and Comparative Examples 1 and 2, a graph showing a relationship between the pH of a dispersion liquid and the ζ potentials of fine particles and aggregated particles thereof is shown in FIG. 2; and a graph showing a relationship between the pH of a dispersion liquid and the volume average particle diameters of fine particles and aggregated particles thereof is shown in FIG. 3.

In FIGS. 2, 101, 102, 201, and 202 show the results of Example 1, Example 2, Comparative Example 1, and Comparative Example 2, respectively.

In FIG. 3, 101′, 102′, 201′, and 202′ show the results of Example 1, Example 2, Comparative Example 1, and Comparative Example 2, respectively.

As shown in the drawings, in the case of Example 1, aggregated particles are formed in at least a region where the ζ potential is −30 mV or more. The change in the particle diameter of the aggregated particles is not sharp and also the particle diameter is stable at a desired level. In the case of Example 2, in a region where the ζ potential is −30 mV, the fine particles are in a state that they are not yet sufficiently aggregated, and in a region where the ζ potential exceeds −30 mV, the aggregation proceeds according to an increase in the ζ potential. Further, the pH when the ζ potential becomes −30 mV is in the range of from 3.0 to 6.9. In both cases, the aggregation is easily controlled by adjustment of ζ potential using pH.

In the case of Comparative Example 1, although the pH when the ζ potential becomes −30 mV is in the range of from 3.0 to 6.9, the dispersion stability is too high, and therefore, the particles do not aggregate.

In the case of Comparative Example 2, the ζ potential never become −30 mV or more, and further, the particle diameter of the aggregated particles sharply changes at around pH 7, and therefore, large particles are generated. Thus, it is found that control of particle diameter is difficult.

TABLE 1

| | | | | | Properties of colored fine |
|---|---|---|---|---|---|
| | Composition of mixed liquid before fine pulverization | | | | particle dispersion liquid |
| | Moderately | | | Ion | Volume average particle |
| | pulverized | | | exchanged | diameter after fine |
| | particles | Anionic surfactant | Amine compound | water | pulverization (μm) |
| Example 1 | 30% | Sodium dodecylbenzene | Triethylamine | 68.00% | 0.70 |
| | | sulfonate 1.00% | 1.0% | | |
| Example 2 | 30% | Sodium dodecylbenzene | Triethylamine | 67.00% | 0.77 |
| | | sulfonate 2.00% | 1.0% | | |
| Example 3 | 30% | Dipotassium alkenyl | Triethylamine | 68.20% | 0.84 |
| | | succinate 0.80% | 1.0% | | |
| Example 4 | 30% | Dipotassium alkenyl | Triethylamine | 67.40% | 0.64 |
| | | succinate 1.60% | 1.0% | | |
| Example 5 | 30% | Dipotassium alkenyl | Triethylamine | 68.30% | 0.98 |
| | | succinate 0.70% | 1.0% | | |
| Example 6 | 30% | Dipotassium alkenyl | Triethylamine | 68.32% | 1.00 |
| | | succinate 0.68% | 1.0% | | |
| Example 7 | 30% | Sodium dodecylbenzene | Triethylamine | 66.50% | 0.58 |
| | | sulfonate 2.50% | 1.0% | | |
| Example 8 | 30% | Sodium dodecylbenzene | Triethylamine | 68.75% | 0.93 |
| | | sulfonate 0.25% | 1.0% | | |
| Comparative | 30% | Sodium dodecylbenzene | Triethylamine | 68.50% | 0.82 |
| Example 1 | | sulfonate 0.50% | 1.0% | | |
| Comparative | 30% | Sodium dodecylbenzene | Triethylamine | 65.00% | 0.70 |
| Example 2 | | sulfonate 4.00% | 1.0% | | |
| Comparative | 30% | Dipotassium alkenyl | Triethylamine | 68.60% | 1.14 |
| Example 3 | | succinate 0.40% | 1.0% | | |
| Comparative | 30% | Dipotassium alkenyl | Triethylamine | 65.80% | 0.69 |
| Example 4 | | succinate 3.20% | 1.0% | | |
| Comparative | 30% | Dipotassium alkenyl | Triethylamine | 68.35% | 1.01 |
| Example 5 | | succinate 0.65% | 1.0% | | |
| Comparative | 30% | Dipotassium alkenyl | Triethylamine | 68.40% | 1.21 |
| Example 6 | | succinate 0.60% | 1.0% | | |
| Comparative | 30% | Sodium dodecylbenzene | Triethylamine | 66.00% | 0.55 |
| Example 7 | | sulfonate 3.00% | 1.0% | | |
| Comparative | 30% | Sodium dodecylbenzene | Triethylamine | 68.80% | 0.97 |
| Example 8 | | sulfonate 0.20% | 1.0% | | |

| | Properties of colored fine | | | | |
|---|---|---|---|---|---|
| | particle dispersion liquid | | Test results | | |
| | Volume average | | | Presence or | Presence or |
| | particle diameter | pH when ζ | Volume average | absence of | absence of |
| | when pH is 7.0 | potential | particle | unaggregated | coalescing |
| | (μm) | is −30 V | diameter (μm) | particles | particles |
| Example 1 | 0.85 | 3.9 | 6.3 | Absence | Absence |
| Example 2 | 1.03 | 3.2 | 5.2 | Absence | Absence |
| Example 3 | 1.54 | 6.5 | 8.7 | Absence | Absence |
| Example 4 | 0.94 | 3.8 | 5.8 | Absence | Absence |
| Example 5 | 1.84 | 6.7 | 9.1 | Absence | Absence |
| Example 6 | 1.98 | 6.8 | 9.8 | Absence | Absence |
| Example 7 | 0.62 | 3 | 4.7 | Absence | Absence |
| Example 8 | 2.00 | 6.9 | 13.6 | Absence | Absence |
| Comparative | 1.74 | 4.6 | 10.4 | Absence | Presence |
| Example 1 | | | | | |
| Comparative | 0.7 | 1 or less | 0.7 | Presence | Absence |
| Example 2 | | | | | |
| Comparative | 12.8 | 7.2 | 15.8 | Absence | Presence |
| Example 3 | | | | | |
| Comparative | 0.78 | 1.5 | 1.3 | Presence | Absence |
| Example 4 | | | | | |
| Comparative | 1.99 | 6.9 | 10.1 | Absence | Presence |
| Example 5 | | | | | |
| Comparative | 2.01 | 7 | 12.4 | Absence | Presence |
| Example 6 | | | | | |
| Comparative | 0.62 | 2.9 | 4.2 | Presence | Absence |
| Example 7 | | | | | |
| Comparative | 2.34 | 7 | 26.8 | Absence | Presence |
| Example 8 | | | | | |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for producing a developing agent comprising:
preparing a toner material dispersion liquid by mixing a granular mixture containing a binder resin and a coloring agent with an aqueous medium;
preparing a dispersion liquid containing fine particles having a particle diameter smaller than that of the granular mixture by subjecting the toner material dispersion liquid to mechanical shearing to finely pulverize the granular mixture; and
forming aggregated particles by aggregating the fine particles through pH adjustment of the dispersion liquid containing the fine particles, wherein
in the formation of the aggregated particles, when the pH of the dispersion liquid is 7, the particles in the dispersion liquid have a volume average particle diameter of 2 μm or less, and when the zeta potential of the particles is −30 mV, the pH of the dispersion liquid is from 3.0 to 6.9.

2. The method according to claim 1, wherein the fine particles have a volume average particle diameter of from 0.05 to 1.0 μm.

3. The method according to claim 1, wherein, in the formation of the aggregated particles, the pH adjustment is performed using at least one acid selected from the group consisting of nitric acid, sulfuric acid, hydrochloric acid, acetic acid, acetic anhydride, phosphoric acid, and citric acid.

4. The method according to claim 1, wherein, in the preparation of the toner material dispersion liquid, at least either one of a surfactant and a basic compound is added.

5. The method according to claim 1, wherein the binder resin is a polyester resin.

6. The method according to claim 1, wherein the binder resin has an acid value of 1 mg KOH/mg or more.

7. The method according to claim 1, wherein the mechanical shearing is performed at a temperature higher than the glass transition temperature of the binder resin.

8. The method according to claim 1, wherein the method further comprises forming toner particles by washing and drying the aggregated particles, and the toner particles have a volume average particle diameter of from 2.5 to 15 μm.

9. The method according to claim 8, wherein the toner particles have a circularity of from 0.8 to 1.0.

10. The method according to claim 8, wherein the aggregated particles are washed until the electrical conductivity of the discharged washing liquid becomes 50 μS/cm or less.

11. The method according to claim 1, wherein the method further comprises encapsulating the aggregated particles by adding a dispersion liquid containing additional fine particles containing a resin component in the formation of aggregated particles to cause heteroaggregation of the fine particles on the surfaces of the aggregated particles.

12. The method according to claim 11, wherein the additional fine particles have a volume average particle diameter of from 0.03 to 1 μm.

13. The method according to claim 1, wherein the granular mixture contains at least either one of a release agent and a charge control agent.
